(19) United States
(12) Patent Application Publication
(10) Pub. No.: US 2011/0202484 A1
(43) Pub. Date: Aug. 18, 2011

(54) ANALYZING PARALLEL TOPICS FROM CORRELATED DOCUMENTS

(75) Inventors: Nikolaos Anerousis, Chappaqua, NY (US); Abhijit Bose, Paramus, NJ (US); Jimeng Sun, White Plains, NY (US); Duo Zhang, Urbana, IL (US)

(73) Assignee: INTERNATIONAL BUSINESS MACHINES CORPORATION, Armonk, NY (US)

(21) Appl. No.: 12/708,053

(22) Filed: Feb. 18, 2010

(51) Int. Cl. G06F 15/18; G06N 5/02

(52) U.S. Cl. 706/12; 706/52

(57) ABSTRACT

Access is obtained to a parallel corpus including a problem corpus and a solution corpus. A first plurality of topics are mined from the problem corpus and a second plurality of topics are mined from the solution corpus. A transition probability from the first plurality of topics to the second plurality of topics is determined, to identify a most appropriate one of the topics from the solution corpus for a given one of the topics from the problem corpus.

### FIELD OF THE INVENTION

The present invention relates to the electrical, electronic and computer arts, and, more particularly, to information technology (IT) problem resolution and the like.

### BACKGROUND OF THE INVENTION

Problem resolution is significant in many practical domains. Historical problem records often include multiple correlated fields, e.g., problem description and solution description. All these fields describe different aspects of the same problem. Topic modeling of these correlated documents is desirable for various analyses and applications Current text mining approaches do not apply well on correlated documents, because current techniques either merge all fields into one document or treat them as independent documents. Correlation across these fields is not captured by current techniques.

### SUMMARY OF THE INVENTION

Principles of the invention provide techniques for analyzing parallel topics from correlated documents. In one aspect, an exemplary method includes the steps of obtaining access to a parallel corpus comprising a problem corpus and a solution corpus;

mining a first plurality of topics from the problem corpus; mining a second plurality of topics from the solution corpus; and determining transition probability from the first plurality of topics to the second plurality of topics to identify a most appropriate one of the topics from the solution corpus for a given one of the topics from the problem corpus.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed.

One or more embodiments of the invention or elements thereof can be implemented in the form of a computer product including a computer readable storage medium with computer usable program code for performing the method steps indicated. Furthermore, one or more embodiments of the invention or elements thereof can be implemented in the form of an apparatus including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

One or more embodiments of the invention may offer one or more of the following technical benefits:
The method can summarize problem and solution databases as two topics of weighted keywords.
The methods can determine the correlation between the problem and solution topics.
The correlation can be used to link new problem(s) to existing solution(s).
Prior knowledge such as expert opinions and labeled data can be easily incorporated into the framework by adjusting initial parameters of the model.

These and other features, aspects and advantages of the invention will become apparent from the following detailed description of illustrative embodiments thereof, which is to be read in connection with the accompanying drawings.

### BRIEF DESCRIPTION OF THE DRAWINGS

FIG. 1 is a table showing exemplary ticket data and its topics;

FIG. 2 is a table showing definitions of symbols as used herein;

FIG. 3 depicts illustrative modeling results;

FIG. 4 shows an exemplary graphical model for general parallel topic modeling, according to an aspect of the invention;

FIG. 5 shows pseudo-code for an exemplary expectation maximization technique for parallel topic modeling, according to another aspect of the invention;

FIG. 6 shows an exemplary graphical model for matching parallel topic modeling, according to still another aspect of the invention;

FIG. 7 shows a flow chart and system block diagram for problem resolution and corpus generation, according to yet another aspect of the invention;

FIG. 8 is a table showing exemplary word distribution;

FIG. 9 is a table showing representative tickets;

FIG. 10 depicts efficiency analysis with different corpus sizes;

FIG. 11 depicts efficiency analysis with different topics;

FIG. 12 is a table showing perplexity versus number of topics;

FIG. 13 is a system block diagram, according to a further aspect of the invention and

FIG. 14 depicts a computer system that may be useful in implementing one or more aspects and/or elements of the invention.

### DETAILED DESCRIPTION OF PREFERRED EMBODIMENTS

As noted, problem resolution is significant in many practical domains. Historical problem records often include multiple correlated fields, e.g., problem description and solution description. All these fields describe different aspects of the same problem. Topic modeling of these correlated documents is desirable for various analyses and applications

Current text mining approaches do not apply well on correlated documents, because current techniques either merge all fields into one document or treat them as independent documents. Correlation across these fields is not captured by current techniques.

In some instances, the correlated topic models can enable new applications as well as enhance existing applications. With respect to topic browsing, as the problem records grow, it is desirable for users to be able to understand over different fields as well as their relationship. In one or more embodiments, Parallel Topic Modeling (PTM) can help characterize the topics in different fields as well as their transition probability. With this model, it is possible to easily select representative records from each topic and highlight the keywords.

With regard to solution search, when a new type of problems occurs, a perfect solution may not exist; however, relevant solutions of the same topic can still be present in the historical records. Due to the lack of key word matches, the standard retrieval will fail. However, at least some embodiments of the invention enhance the search result through a topic-level similarity.

One or more embodiments of the invention provide a correlated document model with two or more textual fields; for example, problem and solution in the problem records. In one or more instances, a PTM technique is employed to learn two or more sets of topics over all correlated fields, respectively, as well as the transition probability between them. PTM is a general probabilistic model that addresses different but correlated sets of topics. Besides a general PTM, several variations are also disclosed herein; for example, a Matching PTM, which assumes the same topics for all fields but with different word distribution; and a Bayesian PTM, which incorporates the prior information to align the topics with the expert's intuition. With regard to this latter aspect, several techniques may be employed with respect to the prior information, namely, through labeled documents (problem records) or through biased keyword distribution.

To address the topic browsing application, leverage select representative records from each topic based on the keyword similarity to the topic keywords and then highlight those keywords according that topic. To address the solution search application, combine the standard keyword based retrieval and the topic-level retrieval into a unified scoring function, based on which solution documents will be fetched.

To handle new emerging topics, at least some instances employ a Dirichlet process to model the problem topics in tickets, in which incoming problem records can be assigned to the previous problem topic or can be regarded as a new problem topic (depending on how likely the document is generated from previous topics). To address the scalability and efficiency problem, a parallel PTM implementation employs MapReduce infrastructure (e.g., Hadoop implementation). This parallel method resolves storage and computation bottlenecks, which enables large-scale practical applications. As will be appreciated by the skilled artisan, Hadoop is an open source distributed computing platform that includes implementations of MapReduce and a distributed file system, while MapReduce is a programming model and an associated implementation for processing and generating large data sets.

One or more embodiments of the invention thus provide a method that learns multiple kinds of topics on multiple fields, and the correlations among the topic sets. In some cases, there are two sets of topics, which assumes the same topics for both problem and solution fields but with different word distribution. In some instances, the prior information is incorporated to align the topics with the expert intuition; in particular, several methods are provided to address the prior information; for example, through labeled documents (problem records) or through biased keyword distribution. In another aspect, scalable computation of the model for large datasets is enabled. In still another aspect, the model is incrementally updated as new data arrives.

Furthermore, one or more embodiments provide a system that in turn provides topic browsing capability through representative record extractions and keyword highlighting on a per topic basis. Still further, one or more embodiments of the invention provide a method that combines keyword-based similarity with topic based similarity into the search ranking function.

Continuous complexity growth in the services industry is driving an increasing number of defects and requires improved techniques for problem resolution. As agents and technicians diagnose and resolve problems on a daily basis, this wealth of information accumulates in problem ticketing systems and can be mined to assist in resolving future incidents. This information effectively constitutes a parallel document with two related textual fields: problem and solution, which describe the problem symptoms and corresponding solutions, respectively. The problem ticket corpus becomes a powerful knowledge-base for helping agents solve future problems. However, while related, problem and solution fields have different characteristics, essentially constituting parallel document corpora.

Aspects of the invention provide a Parallel Topic Model (PTM) method for mining parallel document corpora. In particular, PTM identifies 1) the semantic topics in problem and solution fields and 2) topic transition probability from problem to solution. In addition to general PTM, aspects of the invention also provide several variations, for example, Matching PTM, which assumes one-to-one correspondence between problem and solution topics, and Bayesian PTM, which incorporates prior knowledge on topic distributions. For illustrative purposes, two comprehensive case studies are presented, using the results of PTM for IT problem resolution. In at least some instances, PTM is superior to PLSI (Probabilistic Latent Semantic Indexing), without sacrificing performance.

As the service industry continues to grow, service providers are looking for solutions to manage increasing levels of complexity in their systems. This need is particularly prevalent in the area of problem management. As system complexity grows, so does the domain of problems and their manifestations. Service providers are continuously seeking improved techniques to diagnose problems, identify their root cause and develop and deploy solutions quickly. In some instances, an enterprise employs a group of service providers to handle some or all of its IT systems and processes. The services are typically provided according to contractual Service Level Agreements (SLAs) signed at the time of the service provider selection process. If a provider fails to deliver a service according to the SLA, the provider frequently incurs a financial penalty. Missed SLAs affect customer-perceived quality of the overall service. As a result, most providers have established in-house quality improvement programs, and strive to automate and improve their service delivery processes.

Problem management is a critical part of IT and often represents the largest share of the workload for a provider. It typically has two objectives, problem resolution and process improvement. In problem resolution, when a new problem occurs, agents need to quickly identify the underlying root cause and develop and apply the appropriate solution. During this process, they often need to cross-reference similar problems that occurred in the past to develop the correct solution. In process improvement, periodically, quality analysts in the service provider's delivery organization study the problem record corpus to understand the occurrence characteristics of various problems and to look for potential areas of improvement.

Service providers deploy workflow systems that track the life cycle of problem records from occurrence to resolution. During the lifecycle of a problem, incremental information is added to the record, e.g. when a root cause is found or a solution is identified. A historical service request typically captures the following pieces of information: problem description, corresponding solution, system information, error codes, priority, customer name, etc. Over time, a large number of these records are collected by the provider, which constitutes the core knowledge-base for IT problems and solutions. For example, the table of FIG. 1 shows an example problem record from a service provider. A topic field can be manually added to make the content more clear.

For many service providers, the problem resolution process, from diagnosis to solution design, is manual. Agents perform simple keyword-based search in the problem corpus to look for similar problems that may have happened in the past. Improved search techniques are invaluable in assisting help-desk agents and quality analysts Improved problem search capability typically involves the following issues: (i) how to cluster the problem records into different topics based on either problem description or solution; and (ii) how to select the representative problem records and corresponding key words from a given topic. As it turns out, these two questions can be addressed once a specialized topic model is calculated (see discussion of mining case study and applications below) from the problem record corpus. Then, as a new problem arrives, agents can find a set of topics relevant to the problem at hand, and the representative set of historical records and corresponding solution topics. This significantly reduces the search space of the problem record corpus compared to current state-of-the-art keyword-based searches.

The challenges of topic modeling in the problem management domain include the following:
Problem and solution fields are typically of different topic distributions. This occurs because a problem field describes the symptoms of a problem, while a solution focuses on the steps involved to fix the problem. Although they are related, the word distributions of the two fields turn out to be very different.
The problem and solution topics are not always identical. Multiple problems may lead to the same solution, and one problem may have several possible solutions. Therefore, it is desirable to allow the flexibility of different numbers of problem and solution topics, as well as the association between them.
The problem and solution topics should align with the expert's intuition.

At least some embodiments of the invention model a problem record as a parallel document with two textual fields: problem and solution. The Parallel Topic Modeling (PTM) method can be employed, in at least some instances, to learn two kinds of topics on problem and solution fields, respectively, and the transition probability between them. PTM is a general probabilistic model that addresses different but correlated problem and solution topics. Besides a general PTM, several variations are also disclosed, including Matching PTM, which assumes the same topics for both problem and solution fields but with different word distribution; and Bayesian PTM, which incorporates the prior information to align the topics with the expert intuition. In particular, several methods are disclosed to address the prior information; for example, through labeled documents (problem records) or through biased keyword distribution.

Two non-limiting exemplary case studies are presented from IT service diagnosis using the results of PTM on real IT service data. The performance of PTM is compared quantitatively, in terms of CPU time, memory and perplexity, with other related models such as PLSI.

It should be noted that unlike current techniques, one or more embodiments of the invention mine different sets of topics from two different but correlated corpuses and at the same time analyze the correlations between these two sets of topics, while current techniques either mine one set of topics or focus on mining one set of topics from one single corpus (with citation structure). Furthermore, while some current techniques aim at finding or constructing related answers for questions, one or more embodiments analyze semantic topics embedded in problems and solutions corpus, and provide mining results which can also be used to enhance quality assurance (QA) tasks.

In addition, one or more embodiments focus on building a correlated topic model to characterize the semantic topics embedded in problems and solutions, as well as their correlations, which is useful for various applications.

### Problem Formulation

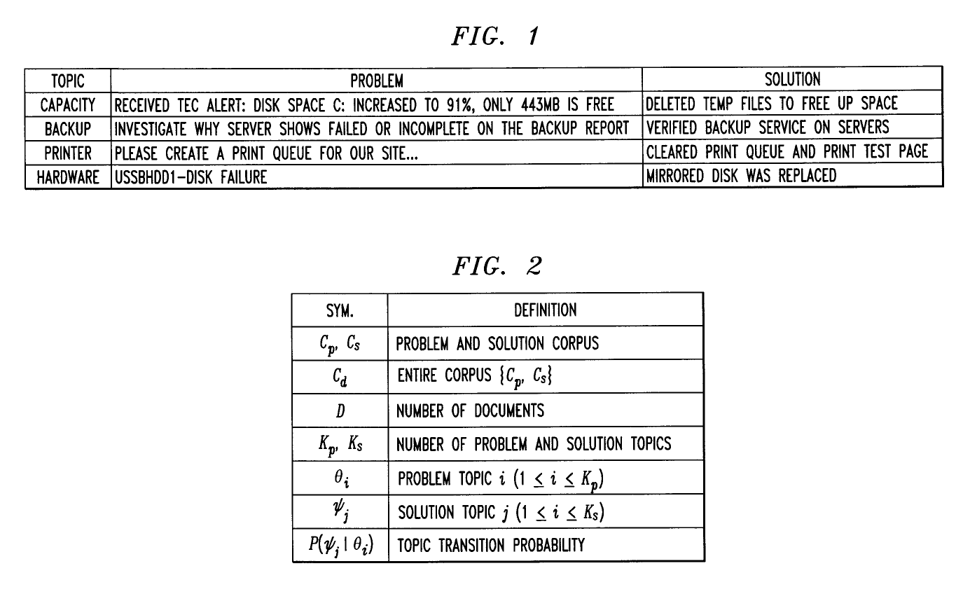

One or more embodiments of the invention address the problem of analyzing a set of parallel documents. One goal is to mine semantic topics from each field, respectively, as well as the correlations among the topics. The terminology and problem formulation employed herein will now be introduced, with reference also to FIG. 2.

Parallel Corpus: A record dᵢ is called a parallel document if it contains two related textual fields, namely problem pᵢ and solution sᵢ, and is denoted as dᵢ =(pᵢ, sᵢ). A Parallel Corpus is a set of such records C_{d}={p₁, s₁), (p₂, s₂), . . . (p_{D}, s_{D})}, where D is the total number of records. Refer to the two collections Cₚ={p₁, p₂, . . . , p_{D}} and Cₛ={s₁, s₂, . . . , s_{D}) as Problem Corpus and Solution Corpus, respectively. Also denote the entire corpus C_{d} as {Cₚ, Cₛ}.

For example, the table of FIG. 1 shows a set of parallel documents, each of which contains a Problem and a Solution field.

Topic: A topic in a text collection C_{d} is a probabilistic distribution over words, which characterizes a semantically coherent topic in the collection. Formally, a topic is represented by a unigram language model θ, i.e., a word distribution:

{P(w|θ)}_{w∈V}s.t Σ_{w∈V}P(w|θ)=1. (1)

Here, V denotes the whole vocabulary of the corpus.

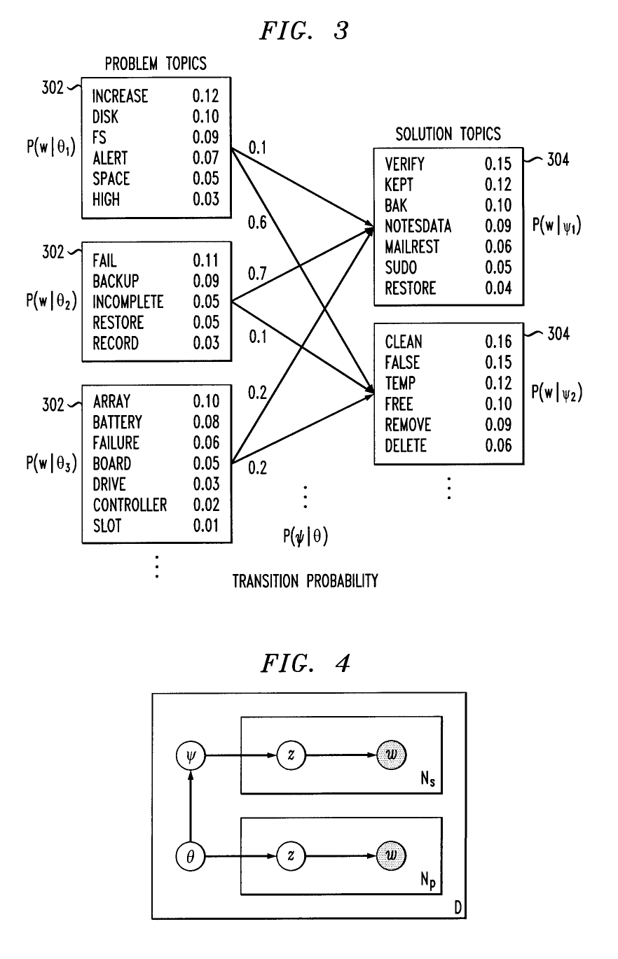

A word with high probability in such a distribution often suggests what the topic is about. For example, a probability distribution which has high probability over the words “tape,” “restore,” and “incomplete” may suggest a topic about backup of data. Parallel Topic Modeling (PTM): Given a parallel corpus {Cp, Cs}, the goal of Parallel Topic Modeling (PTM) is to mine Kₚ topics {θᵢ}ᵢ₌₁^{K}^{ₚ} from the problem corpus Cₚ and Kₛ topics {υ/ⱼ}ⱼ₌₁^{K}^{ₛ} from the solution corpus Cₛ, as well as the Kₚ ×Kₛ transition probability from problem to solution topics, i.e. P(υ/ⱼ|θᵢ) for i=1, . . . , Kₚ and j=1, . . . , Kₛ. FIG. 3 shows a visual illustration of the model including problem topics 302 and solution topics 304.

One significant aspect of parallel corpus topic modeling is that it mines two sets of topics from two correlated text corpuses and also analyzes the correlations between these two sets of topics. For example, in the ticket data described in the table of FIG. 1, the parallel corpus topic modeling task will mine topics such as “Capability Problem” and “Hardware Problem” from the problem corpus and topics such as “Deletion Operation” and “Replace Operation” from the solution corpus. At the same time, the task will also indicate which solution topic is the most appropriate one for a problem topic. For example, the “Deletion Operation” could be the best solution for the “Capability Problem.”

### Parallel Topic Modeling

Disclosed herein are a formalized PTM model and an expectation maximization (EM) technique to learn the model parameters.

Model Description: A graphical representation of PTM is described in FIG. 4. In this model, the variable θ represents the probability of selecting a topic from all the possible Kₚ problem topics given a parallel document d, i.e. P(θᵢ|d). Similarly, ψ represents the probability of selecting a topic from all the possible Kₛ solution topics given a parallel document d, i.e., P(υ/ᵢ|θⱼ). Nₚ and Nₛ represent the number of words in the problem field and the solution field of a parallel document, respectively. Note that z is an indicator variable and w is a word.

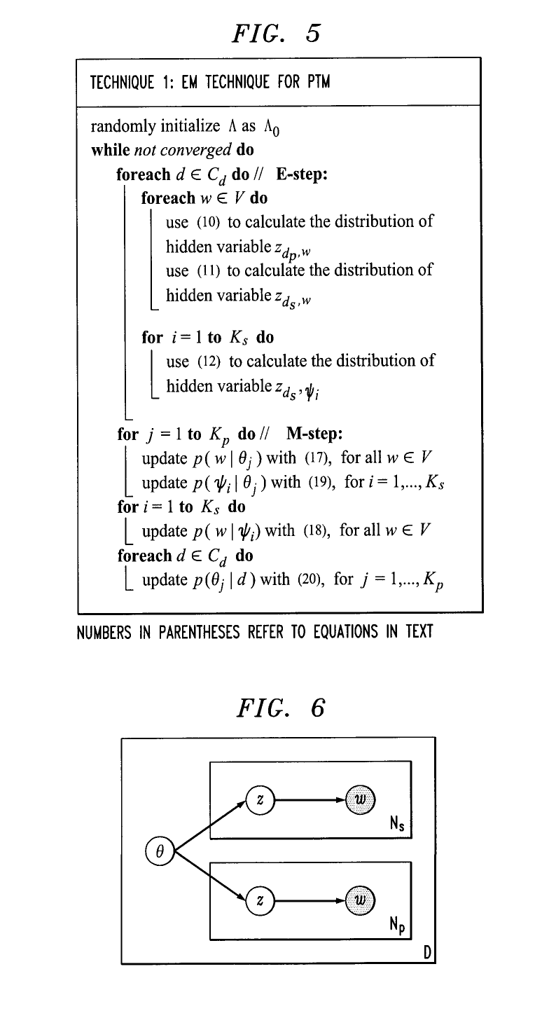

With this generative model, a parallel document with both its problem field and solution field is generated as seen in FIG. 5. Since a problem topic is usually associated to fixed solution topics, assume the probability of a solution topic is independent of the data record, i.e.:

P(υ/ᵢ|θⱼ, d)=P(υ/ᵢ|θⱼ). (2)

Therefore, the probability P(υ/ᵢ|d) can be calculated as follows:

$$P ( {ψ}_{i} \vert d ) = {\sum }_{j = 1}^{{K}_{p}} P ( {ψ}_{i} , {θ}_{j} \vert d ) = {\sum }_{j = 1}^{{K}_{p}} \{ P ( {ψ}_{i} \vert {θ}_{j} ) P ( {θ}_{j} \vert d ) \} \qquad ( 3 )$$

Based on the generative process described by the model, the likelihood of a word w in the problem field of a document d is:

$${P}_{p} ( w \vert d ) = {\sum }_{j = 1}^{{K}_{p}} P ( {θ}_{j} \vert d ) P ( w \vert {θ}_{j} ) \qquad ( 4 )$$

Furthermore, the likelihood of a word w in the solution field is:

$$\begin{matrix}{P}_{s} ( w \vert d ) = {\sum }_{j = 1}^{{K}_{s}} P ( {ψ}_{j} \vert d ) P ( w \vert {ψ}_{j} ) \\ = {\sum }_{j = 1}^{{K}_{s}} \{ {\sum }_{i = 1}^{{K}_{p}} P ( {ψ}_{j} \vert {θ}_{i} ) P ( {θ}_{i} \vert d ) \} P ( w \vert {ψ}_{j} )\end{matrix} \qquad ( 5 )$$

Therefore, the log-likelihood of the whole corpus is:

$$L = {\sum }_{d ∈ {C}_{d}} {\sum }_{w ∈ V} \{ c ( w , {d}_{p} ) log {P}_{p} ( w \vert d ) + c ( w , {d}_{s} ) log {P}_{s} ( w \vert d ) \} + {\sum }_{d ∈ {C}_{d}} {\sum }_{w ∈ V} c ( w , d ) log P ( d ) , \qquad ( 6 )$$

where c(w, d) is the count of a word w in a parallel document d, c(w, dₚ) is the count of w in d′s problem field, and c(w, dₛ) is the count of w in d's solution field. Here, use dₚ and dₛ to represent the problem field and the solution field in record d respectively.

If the maximum likelihood estimator is used to calculate the parameters, P(d) will be proportional to the length of d, which does not depend on the other parameters related to topics. In this sense, P(d) can be treated as a constant, and therefore maximizing the original log-likelihood of the corpus L is equal to maximizing the following objective function L′:

$${L}^{′} = {\sum }_{d ∈ {C}_{d}} {\sum }_{w ∈ V} \{ c ( w , {d}_{p} ) log {p}_{p} ( w \vert d ) + c ( w , {d}_{s} ) log {p}_{s} ( w \vert d ) \} = {\sum }_{d ∈ {C}_{d}} {\sum }_{w ∈ V} c ( w , {d}_{p} ) log {\sum }_{j = 1}^{{K}_{p}} P ( w \vert {θ}_{j} ) P ( {θ}_{j} \vert d ) + {\sum }_{d ∈ {C}_{d}} {\sum }_{w ∈ V} c ( w , {d}_{s} ) log {\sum }_{i = 1}^{{K}_{s}} \{ {\sum }_{j = 1}^{{K}_{p}} P ( {ψ}_{i} \vert {θ}_{j} ) P ( {θ}_{j} \vert d ) \} P ( w \vert {ψ}_{i} ) , \qquad ( 7 )$$

with constraints:

$$\{ \begin{matrix}{\sum }_{i = 1}^{{K}_{p}} P ( {θ}_{i} \vert d ) = 1 & for d ∈ {C}_{d} \\ {\sum }_{w} P ( w \vert {θ}_{j} ) = 1 & for j = 1 , … , {K}_{p} \\ {\sum }_{w} P ( w \vert {ψ}_{i} ) = 1 & for i = 1 , … , {K}_{s} \\ {\sum }_{i = 1}^{{K}_{s}} P ( {ψ}_{i} \vert {θ}_{j} ) = 1 & for j = 1 , … , {K}_{p}\end{matrix} \qquad ( 8 )$$

Use A to denote parameters:

{P(w|θᵢ)}V×Kₚ,

{P(w|υ/ⱼ)}V×Kₛ,

{P(θᵢ|d(}Kₚ×C_{d},

{P(υ/ⱼ|θᵢ)}Kₛ×Kₚ, (9)

which will be used to estimate in the model.

Parameter Estimation: Techniques will now be disclosed to estimate the parameters A using the maximum likelihood estimator, which selects parameter values that maximize the data likelihood as the estimation result. Note that PTM is a mixture model, and finding the global maximum can be carried out, for example, using an Expectation-Maximization (EM) technique to estimate the parameters. The technique is shown in the pseudo code of FIG. 5.

The E-step is shown in equations 10-12 below. Note that {Z_{d}_{ₚ},w} is a hidden variable and P(Z_{d}_{ₚ},w=j) indicates the probability of a word w in dₚ generated from topic θj. Similarly, {Z_{d}_{ₛ},w} hidden variable indicating the probability of a word w generated from a solution topic in dₛ. In addition, {Z_{d}_{^{s}},υ/ᵢ} is another hidden variable and P(Z_{d}_{ₛ},υ/ᵢ=j} is the probability that an answer topic 104 ᵢ in dₛ is selected based on a question topic θj.

$$\begin{matrix}P ( {z}_{{d}_{p} , w} = j ) ∝ {P}^{( m )} ( w \vert {θ}_{j} ) {P}^{( m )} ( {θ}_{j} \vert d ) & ( 10 ) \\ P ( {z}_{{d}_{s} , w} = i ) ∝ {P}^{( m )} ( w \vert {ψ}_{i} ) {\sum }_{j = 1}^{{K}_{p}} {P}^{( m )} ( {ψ}_{i} \vert {θ}_{j} ) {P}^{( m )} ( {θ}_{j} \vert d ) & ( 11 ) \\ P ( {z}_{{d}_{s} , {ψ}_{i}} = j ) ∝ {P}^{( m )} ( {ψ}_{i} \vert {θ}_{j} ) {P}^{( m )} ( {θ}_{j} \vert d ) & ( 12 )\end{matrix}$$

With the following constraints:

Σᵢ₌₁^{K}^{ₚ}P(θᵢ|d)=1, (13)

Σ_{w}P(w|θⱼ)=1, (14)

Σ_{w}P(w|υ/ᵢ)=1, and (15)

Σᵢ₌₁^{K}^{ₛ}P(υ/ᵢ|θⱼ)=1, (16)

the M-step can be calculated by equations 17-20.

$$\begin{matrix} {P}^{( m + 1 )} ( w \vert {θ}_{j} ) ∝ {\sum }_{d} c ( w , {d}_{p} ) P ( {z}_{{d}_{p} , w} = j ) & ( 17 ) \\ {P}^{( m + 1 )} ( w \vert {ψ}_{i} ) ∝ {\sum }_{d} c ( w , {d}_{s} ) P ( {z}_{{d}_{s} , w} = i ) & ( 18 ) \\ {P}^{( m + 1 )} ( {ψ}_{i} \vert {θ}_{j} ) ∝ {\sum }_{d} {\sum }_{w} c ( w , {d}_{s} ) P ( {z}_{{d}_{s} , w} = i ) P ( {z}_{{d}_{s} , {ψ}_{i}} = j ) & ( 19 ) \\ {P}^{( m + 1 )} ( {θ}_{j} \vert d ) ∝ {\sum }_{w} c ( w , {d}_{p} ) P ( {z}_{{d}_{p} , w} = j ) + {\sum }_{w} c ( w , {d}_{s} ) \{ {\sum }_{i = 1}^{{K}_{s}} P ( {z}_{{d}_{s} , w} = i ) P ( {z}_{{d}_{s} , {ψ}_{i}} = j ) \} & ( 20 )\end{matrix}$$

The EM technique converges when it achieves a local maximum of the log likelihood. However, this may not be the global maximum point. So in general, run multiple trials to improve the local maximum obtained.

Matching PTM: A special case of PTM called Matching PTM is shown in FIG. 6. In this case, the number of topics embedded in the problem corpus and the solution corpus are assumed to be the same, and it is further assumed that there are one-to-one correlations between the two sets of k topics. Therefore, as shown in the figure, the problem field and the solution field from the same parallel document share the same topic coverage (denoted by variable θ). Other variables are as defined above.

The log likelihood of the whole corpus defined by this special model can be calculated by equation 22 below. Note that words in the problem field and words in the solution field are generated from different sets of topics, but these two fields share the same portion of topics, i.e.:

$$\begin{matrix} P ( {θ}_{i} \vert d ) = P ( {ψ}_{i} \vert d ) , for i = 1 , … , K . & ( 21 ) \\ L = {\sum }_{d ∈ {C}_{d}} {\sum }_{w ∈ V} c ( w , {d}_{p} ) log {\sum }_{j = 1}^{K} P ( w \vert {θ}_{j} ) p ( {θ}_{j} \vert d ) + {\sum }_{d ∈ {C}_{d}} {\sum }_{w ∈ V} c ( w , {d}_{s} ) log {\sum }_{j = 1}^{K} P ( w \vert {ψ}_{j} ) P ( {θ}_{j} \vert d ) & ( 22 )\end{matrix}$$

This special case can be widely used in many different applications, for example, web pages and tags. Listed below are exemplary formulas used by the EM technique which estimates the parameters in the model, shown from equations 23-27.

$$\begin{matrix} P ( {z}_{{d}_{p} , w} = j ) ∝ {P}^{( m )} ( w \vert {θ}_{j} ) {P}^{( m )} ( {θ}_{j} \vert d ) & ( 23 ) \\ P ( {z}_{{d}_{s} , w} = i ) ∝ {P}^{( m )} ( w \vert {ψ}_{i} ) {P}^{( m )} ( {θ}_{i} \vert d ) & ( 24 ) \\ {P}^{( m + 1 )} ( w \vert {θ}_{j} ) ∝ {\sum }_{d} c ( w , {d}_{p} ) P ( {z}_{{d}_{p} , w} = j ) & ( 25 ) \\ {P}^{( m + 1 )} ( w \vert {ψ}_{i} ) ∝ {\sum }_{d} c ( w , {d}_{s} ) P ( {z}_{{d}_{s} , w} = i ) & ( 26 ) \\ {P}^{( m + 1 )} ( {θ}_{j} \vert d ) ∝ {\sum }_{w} c ( w , {d}_{p} ) P ( {z}_{{d}_{p} , w} = j ) + {\sum }_{w} c ( w , {d}_{s} ) P ( {z}_{{d}_{s} , w} = j ) & ( 27 )\end{matrix}$$

Bayesian PTM: A variation of PTM, which incorporates the prior knowledge into the model through MAP (maximum a posteriori) instead of maximum likelihood to estimate the parameters, will now be disclosed. In particular, several different ways of incorporating prior knowledge will be disclosed, through P(w|θ) and P(θ|d).

Prior on) P(w|θ): When addressing problems of printers, words like “print,” “quality,” and “queue” are frequently mentioned. These kinds of keywords are regarded as the prior knowledge about the “Printer Problem” topic. It is desirable to put more weight on those important words.

More formally, suppose some keywords are known about a problem topic θⱼ, then a unigram language model {p′(w|θⱼ)}_{w∈V} can be built based on these keywords and a Dirichlet prior Dir({σ₁p′(w|θⱼ)}_{w∈V}) can be defined for θⱼ, where σ₁ is a confidence parameter for the prior. For example, it is possible to give those keywords very high probability in p′(w|θⱼ) but to also give a very low probability to other words. Since this prior is conjugate to the multinomial distribution P(w|θⱼ) for topic θⱼ, the value σ₁p′(w|θⱼ) can be viewed as pseudo counts when estimating the topic θⱼ. Therefore, the updating formula for P(w|θⱼ) in the EM technique is changed to equation 28:

$${P}^{( m + 1 )} ( w \vert {θ}_{j} ) = \frac{{\sum }_{p} c ( w , q ) P ( {z}_{q , w} = j ) + {σ}_{1} {p}^{′} ( w \vert {θ}_{j} )}{{\sum }_{{w}^{′}} {\sum }_{p} c ( {w}^{′} , q ) P ( {z}_{q , {w}^{′}} = j ) + {σ}_{1}} \qquad ( 28 )$$

Prior on P(θ|d): On the other hand, some data records have manually assigned categories, which indicate what kind of problem the record describes. This kind of category information can also be regarded as the prior knowledge about the problem topics in this record.

Suppose there is a category label for a record d. A Dirichlet prior Dir({σ₂P′(θⱼ|d)}ⱼ₌₁, . . . , Kₚ) can be added on the parameter P(θ|d), where σ₂ is also a confidence parameter for the prior and ΣⱼP′(θⱼ|d)=1. For example, it is possible to give a very high probability to a problem topic (category) in {P′(θⱼ|d)}ⱼ₌₁, . . . , Kₚ for those documents which are labeled in that category. Therefore, the updating formula for P(w|θⱼ) in the EM technique is changed to equation 29:

$${P}^{( m + 1 )} ( {θ}_{j} \vert d ) ∝ {\sum }_{w} c ( w , {d}_{p} ) P ( {z}_{{d}_{p} , w} = j ) + {\sum }_{w} c ( w , {d}_{s} ) \{ {\sum }_{i = 1}^{{K}_{s}} P ( {z}_{{d}_{s} , w} = i ) P ( {z}_{{d}_{s} , {ψ}_{i}} = j ) \} + {σ}_{2} {P}^{′} ( {θ}_{j} \vert d ) \qquad ( 29 )$$

Note that all the prior knowledge is added on the problem part of the original PTM model. This suggests that Bayesian PTM is useful when there is some knowledge of the problem topics, but uncertainty exists about their solutions. For example, if, usually, it is known that there are descriptions of problems in “hardware” and “network” in the ticket data, then keywords about these problems can be used as the prior knowledge. On the other hand, if exactly how many kinds of general solutions exist for these general problems may not be known. Thus, in this case, the Bayesian PTM model can help in finding out possible general solutions for a set of specific or targeted problems.

### Mining Case Study and Applications

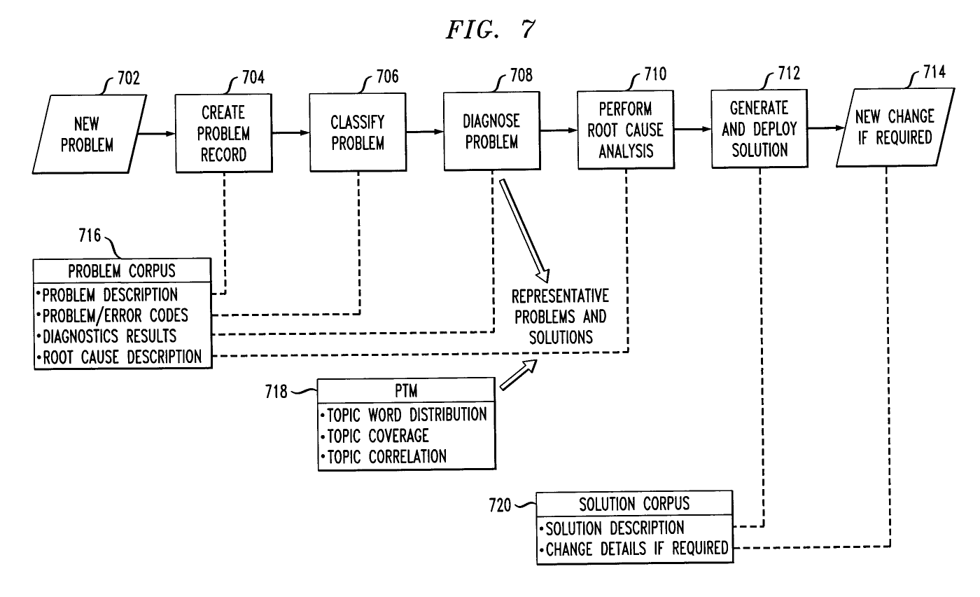

FIG. 7 is a flow chart showing the primary steps involved in problem management. Problems first originate from multiple layers of an enterprise IT system stack, such as hardware, operating system (OS), and business processes running on the infrastructure. When a new problem 702 is detected, a problem record 704 is created with a text description of the problem that is either machine- or human-generated. Then, the problem is classified as at 706 and dispatched to a human agent for problem diagnosis at 708 and root cause analysis at 710, which is followed by the step 712 of generating a solution that will address the underlying root cause. A separate solution record is created at 712 to document the required steps of the solution. If a change is needed, as at 714, the change details are also specified in solution text at 720. Problem corpus 716 can include, for example, a problem description, problem and/or error codes, diagnostic results, and a root cause description, obtained, for example, from steps 704-710. Parallel topic modeler 718 can include, for example, topic word distribution, topic coverage, and topic correlation, and can be used to identify representative problems and solutions for assistance with steps 708-712. Solution corpus 720 can include, for example, a solution description and change details (if needed) obtained, for example, from steps 712 and 714.

One or more embodiments of the PTM approach can significantly improve the problem diagnosis and solution steps of the resolution process in most cases. Exemplary mining results of the PTM model are presented below, and then, the applications of PTM in problem management are discussed and evaluated.

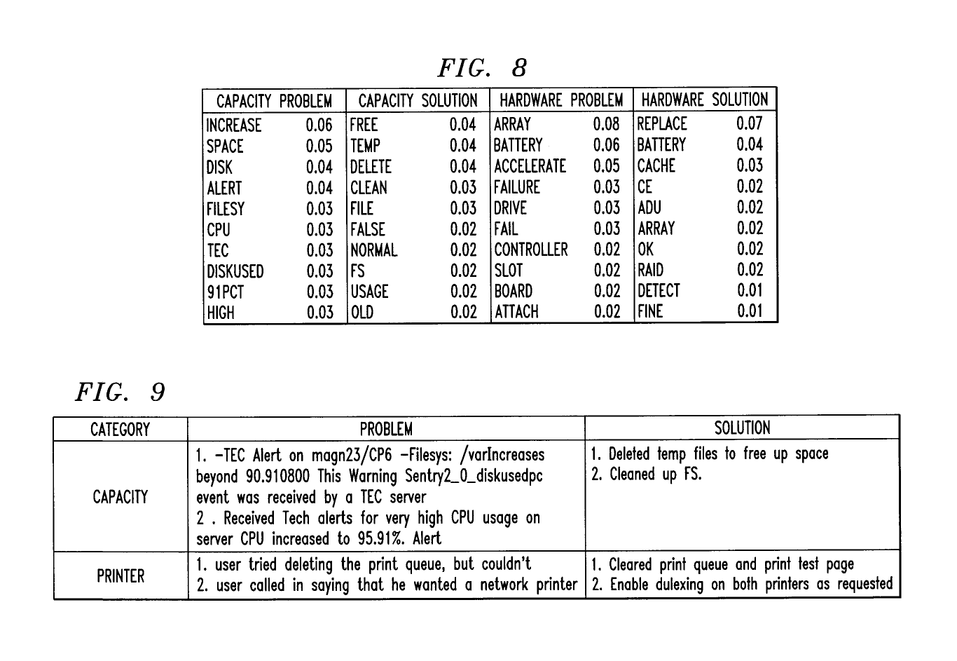

Mining Results: The table of FIG. 8 shows two problem topics and their most relevant solution topics, in which only the top k words, which have the highest probability in the distribution of a topic, are shown. In at least some instances, the keywords in the problem field are mainly about descriptive words such as “alert,” “CPU,” “controller,” while the solution field focuses on actions such as “delete” and “transfer.” This demonstrates that, in at least some embodiments, problem and solution generally use different vocabularies and should not be mixed together for mining.

Process improvement: One application of PTM is to help human experts to manipulate and analyze ticket data by their problem topics and solution topics, especially when the experts dig into an abnormally increasing category of problems and analyze thousands of tickets in that category. In PTM, each category of problems is characterized by a word distribution, and the most relevant solution topics to a problem topic are also provided in the mining results. With these mining results, it is possible to select several representative tickets for each problem topic and its related solution topics, so that experts can quickly get an overview.

Specifically, one or more embodiments can employ a technique which is similar to the MMR technique proposed in J. Carbonell at al., “The use of mmr, diversity-based reranking for reordering documents and producing summaries,” In SIGIR '98, pages 335-36, ACM, New York, N.Y., USA, 1998, in order to find out the most representative tickets in each topic. For example, suppose it is desired to find the most representative tickets for a problem topic θᵢ. First, build a document language model η_{dp} for each ticket's problem field dₚ, in which P(w|ηₚ)∝c(w, dₚ). Then, calculate the similarity between each η_{dp} and θᵢ (e.g. negative KL-divergence between them), and select tickets from the most similar one. Whenever a ticket is selected, all the other non-selected tickets' representative scores will be updated by penalizing their maximum similarity (e.g. cosine similarity) with the selected tickets. The concrete calculation is shown in the following formula, where S is the set of already selected tickets. Repeat this process and select tickets one by one until a certain number of representative tickets are obtained:

$$Rep ( {d}_{p} ) = λ ( Sim ( {θ}_{i} , {η}_{{d}_{p}} ) ) - ( 1 - λ ) {max}_{{d}_{p}^{′} ∈ S} Sim ( {η}_{{d}_{p}} , {η}_{{d}_{p}^{′}} ) \qquad ( 30 )$$

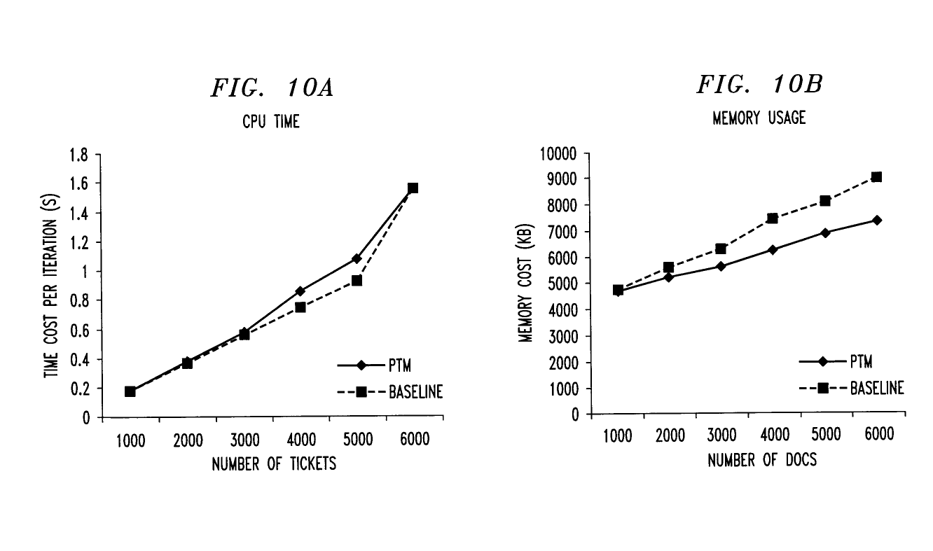

Notice that if λ is set equal to 1, the method becomes simply ranking the tickets based on their relevance, which results in many duplicate tickets. The table of FIG. 9 shows some representative tickets for two problem topics and some representative tickets in their correlated solution topic.

Solution Recommendation: Another application of PTM is to suggest solutions from an archive for agents when they need to resolve a new problem. If the problem description is used as a query, a simple retrieval method may not be good enough if the problem description has little overlap with previous tickets. To improve the retrieval accuracy, the mining result of PTM can be leveraged to smooth the original query, which can be also regarded as an expansion of the original query, as the skilled artisan will appreciate given the teachings herein and current work such as C. Zhai et al., “Model-based feedback in the language modeling approach to information retrieval,” in CIKM '01, pages 403-10, ACM, New York, N.Y., USA, 2001. When a new ticket q arrives, first use the folding-in method proposed in T. Hofmann, “Unsupervised learning by probabilistic latent semantic analysis,” Mach. Learn., 42(1-2):177-96, 2001 (hereinafter, Hofmann), to calculate {P(θ|q)} in the problem description. In essence, fix the parameters {P(w|θ)} are estimated from the training data, and then employ the EM technique used in PLSA to estimate {P(θ|q)}. After that, use the transition probability {P(υ/|θ)} calculate the solution topic coverage for q, i.e., {P(υ/|q)}. Then, the smoothed query language model is calculated as follows:

$${P}^{′} ( w \vert q ) ∝ λ P ( w \vert q ) + ( 1 - λ ) ( {\sum }_{i = 1}^{{K}_{p}} P ( w \vert {θ}_{i} ) P ( {θ}_{i} \vert q ) + {\sum }_{j = 1}^{{K}_{s}} P ( w \vert {φ}_{j} ) P ( {φ}_{j} \vert q ) ) , \qquad ( 31 )$$

where P(w|q) is the original query language model in which P(w|q)∝c(w, q).

Use the KL-divergence retrieval model, known per se from J. Lafferty at al., “Document language models, query models, and risk minimization for information retrieval,” in SIGIR '01, pages 111-19, ACM, New York, N.Y., USA, 2001, to rank all the tickets in the archive, where a document language model is built for each ticket, based on both its problem field and solution field. In a non-limiting experiment, 2500 tickets were randomly selected as the archive and training data, and another 200 tickets were randomly selected as the test data. For each test ticket, its problem field was used as a query and relevant tickets were retrieved using both an embodiment of the invention and a basic retrieval approach. To compare the results of the two approaches, compute the cosine similarity between the real solution of each test ticket and the top ten suggested tickets' solutions. A higher similarity means better recommendations. In the experiment, both the number of problem topics and solutions topics were set as 9 and the combination weight λ was set as 0.95. The experimental result shows that in those 200 testing tickets, the PTM based retrieval method improves the similarity in 17 tickets while hurts the similarity in 7 tickets, which means that overall the exemplary method improves 5% solution recommendations over the baseline. Notice that the experiment was conducted on real data which contains a lot of duplicate tickets, for which even the baseline method works well. Without these duplicates, the improvement of the exemplary method could be even higher.

### Experiment

Non-limiting exemplary results are presented to evaluate the PTM model from a quantitative perspective. First, the performance of the model is examined in terms of CPU time and memory usage. Next, the generalization performance of the PTM model is evaluated.

Efficiency Analysis: Theoretically, the time complexity of each EM iteration for estimating PTM is O((Kₚ+Kₛ)MN_{avg}), where N_{avg} is the average number of unique words in each document. In this section, the efficiency of the PTM model in real cases is examined. Two metrics are used: (1) CPU time, i.e., the average time cost of the technique to finish one iteration of EM; and (2) memory usage, i.e., the maximum memory usage of the technique in the whole process. The PLSA model is sued as a baseline for comparison.

Experimental Setup: More than 12,000 ticket records were randomly collected as testing data, each of which has both a problem field and a solution field. As for the comparison of CPU time, the baseline method uses PLSA to run on the problem corpus and the solution corpus separately, and then adds the average time cost per iteration on the problem corpus and solution corpus together as the total average time cost for it. Similarly, for the comparison of memory, add the memory usage of PLSA on both the corpuses together as the memory usage.

There are two significant factors in the PTM models which affect its total cost: the total number of documents in the corpus M and the number of topics Kₚ and Kₛ. The experiment examines the performance of PTM against these two factors.

All the experiments were performed on a machine with 1 GB RAM and a 3.2 GHz CPU, it being understood that these are exemplary non-limiting values.

Scalable to the number of documents: One thousand to six thousand tickets were randomly selected from the data set to test the scalability of the technique on different sizes of corpus. The other parameters were also fixed as per the following. The number of topics in the problem and solution corpuses were taken as 10 and 5. The number of total unique words in the data set is 9469. For each trial, run PTM and baseline 10 times each and compute the average time per iteration. For the memory usage, use the maximum memory usage during the entire run. Since there are some common memory costs for both PTM and PLSA (e.g. the memory cost of loading the inverted index of the whole corpus), deduct that part from the results and only compare the actual memory usage of each technique.

FIG. 10(a) plots CPU time as a function of the number of documents. It can be seen that the time cost for PTM per iteration is almost the same as the baseline PLSA model, despite the fact that PTM mines more patterns, such as topics transition probability. In addition, PTM is a scalable method since CPU time increases almost linearly as the number of documents, which confirms the theoretical analysis. From FIG. 10(b), it is seen that the total memory usage for the baseline method is a little larger than the PTM model. This is because in the baseline method, the PLSA model needs to store twice the topic portion parameters {P(θᵢ|p)} and {P(υ/ⱼ|s)} parameters for both problem and solution corpuses. On the other hand, PTM only stores one set of topic portion parameters {P(θᵢ|p)} and a set of topic correlation parameters {P(υ/ⱼ|θᵢ)} which do not depend on the number of documents. Therefore, the total memory usage of PTM is smaller than the baseline method.

Scalable to the number of topics: In this experiment, the technique's efficiency was tested by changing the number of topics, while fixing the other parameters, e.g. the size of document corpus is set to 2500. Set the number of solution topics Kₛ as half of the number of problem topics.

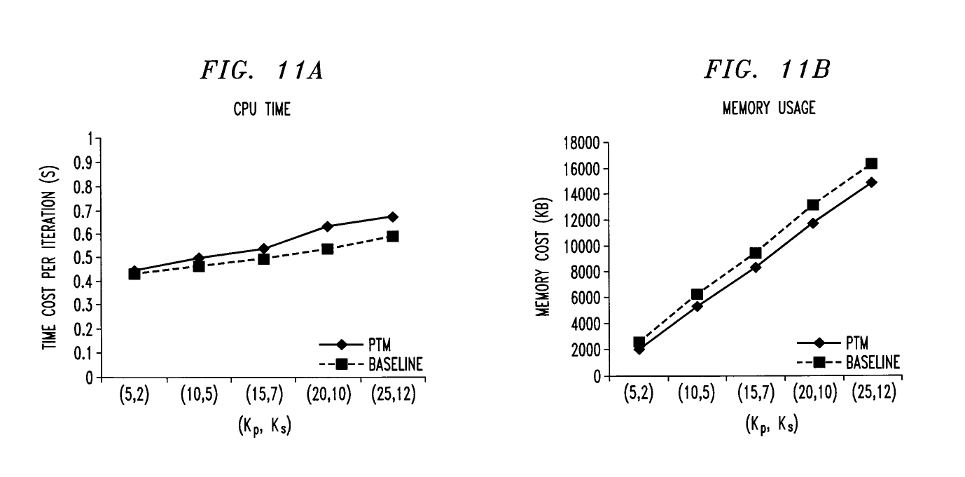

FIG. 11 shows the experimental results, from which similar conclusion as from

FIG. 10 are obtained. Note that both the CPU time and the memory usage increase linearly as the number of topics, which confirms the theoretical analysis.

In summary, in one or more exemplary embodiments, despite the fact that PTM provides richer mining results as compared with traditional topic models, it does not sacrifice any performance in CPU time and memory usage.

Generalization Performance: To test the generalization performance of the PTM model, first train the model and estimate all its parameters on a set of training corpuses, and then compute the perplexity of a test corpus. The formula for computing the perplexity is:

$$perplex ( {D}_{test} ) = exp \{ - \frac{{\sum }_{d ∈ {D}_{test}} {\sum }_{w ∈ V} c ( w , d ) log P ( w \vert d )}{{\sum }_{d ∈ {D}_{test}} {N}_{d}} \} \qquad ( 32 )$$

where N_{d} is the length of document d. Low perplexity indicates a good fit to the test data, and therefore, better generalization power.

The folding-in method proposed in Hofmann was employed to calculate P(w|d) in the test data set. Basically, fix the parameters {P(w|θ), P(w|υ/), P(υ/|θ)} which are estimated from the training data, and then use the EM technique described in equations 10-12 and 20 to estimate {P(θ|d)} in each ticket in the test data. After that, use equation 7 to calculate P(w|d).

The baseline method is a variant of PLSA, which builds two PLSA models for problem and solution corpus independently and then estimates the correlations between problem and solution topics. First, use PLSA to mine Kₚ topics {θᵢ}ᵢ₌₁^{K}^{ₚ} from the problem corpus {p₁, p₂, . . . , p_{D}} and Kₛ topics {υ/ⱼ}ⱼ₌₁^{K}^{ₛ} from the solution corpus {s₁, s₂, . . . , s_{D}} in the training data separately. Then, for each topic θᵢ, it is possible to use the parameters {P(θᵢ|p₁), P(θᵢ|p₂), . . . , P(θᵢ|p_{D})} estimated from the training data to construct a vector \vec{θ}ᵢ for θᵢ. Similarly, it is also possible to construct a vector \vec{υ/}ⱼ₌(P(υ/ⱼ|s₁), P(υ/ⱼ|s₂), . . . , P(υ/ⱼ|s_{D})) for each topic ψⱼ. Based on these vectors, it is possible to calculate the correlations between {θᵢ} and {υ/ⱼ}. . For example, it is possible to set P(υ/ⱼ|θᵢ)∝ cos(\vec{θ}ᵢ, \vec{υ/}ⱼ)). On the test data, first fix the parameters {P(w|θ)} and use PLSA to estimate the parameters {P(θᵢ|d)} from the problem corpus in the test data. Then, based on the correlations between {θᵢ} and {υ/ⱼ}, it is possible to calculate the probability P(w|d) also by equation 7.

In the non-limiting experiment, 2500 tickets were randomly collected as the training data and 200 tickets were randomly collected as the test data. The experimental result is shown in the table of FIG. 12. As the number of topics mined from the corpus increases the perplexity of both methods decreases. In the meantime, for each setting of topic numbers, PTM obtained lower perplexity than the baseline method. This means that one or more embodiments of the PTM model have better generalization performance than the baseline method which is based on the traditional PLSA model.

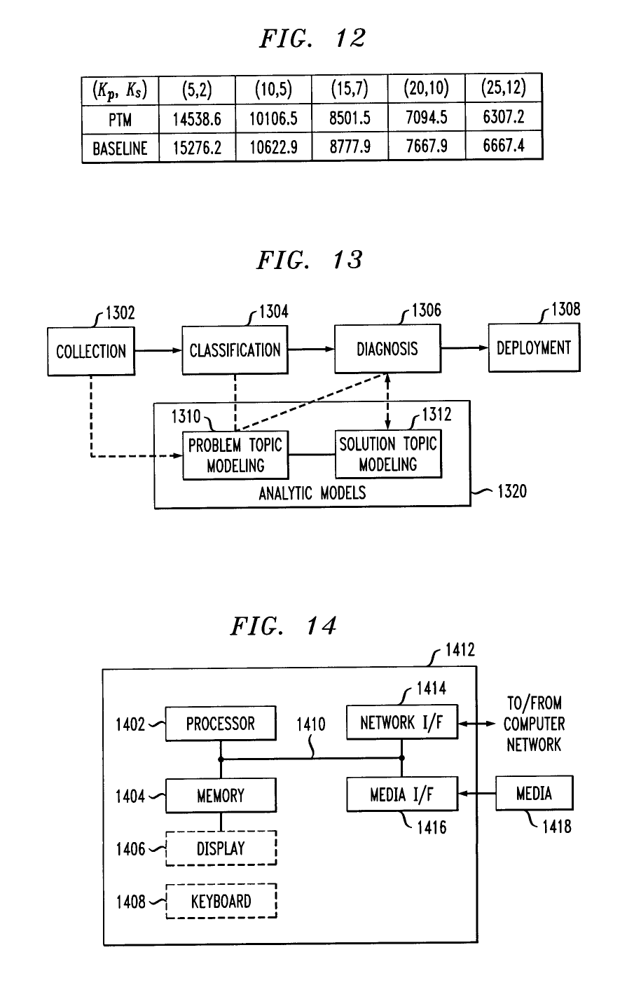

FIG. 13 illustrates a non-limiting exemplary embodiment of a system, according to an aspect of the invention. A first component at 1302 (which can be, for example, an external component) collects and manages raw data such as problem tickets through software systems including data storage and distributed data collection capability. A second component at 1304 (which can be, for example, an external component) classifies those data into different categories based on different problem characteristics. A third component at 1306 (which can be, for example, an external component) provides diagnosis assistance for identifying the solutions such as ticket browsing and search capabilities. A fourth component at 1308 (which can be, for example, an external component) deploys the solutions and records the outcome. In one or more embodiments, besides the external components, there are internal components, such as the analytic models in 1320 that interact with and support different external components. Component 1302 feeds problem text data into the internal component 1310; then component 1310 models the problem text as different topics and helps component 1304 to determine the classification automatically. Component 1306 provides input (solution text data) to internal component 1312; problem topics from component 1310 and solution topics from component 1312 also support the diagnosis process in component 1306.

### Recapitulation

One or more embodiments of the invention provide a novel approach, called PTM, for generating and correlating two sets of topics from two correlated text corpuses. The approach can be applied it to the IT problem resolution process. Two non-limiting case studies demonstrated PTM's usage and its value in real applications. Quantitative evaluation results show the efficiency of PTM with increasing corpus and topic sizes in terms of memory and CPU usage.

Given the discussion thus far, it will be appreciated that, in general terms, an exemplary method, according to an aspect of the invention, includes the step of obtaining access to a parallel corpus including a problem corpus 716 and a solution corpus 720. The method further includes mining a first plurality of topics 302 from the problem corpus 716 and mining a second plurality of topics 304 from the solution corpus 720. Still further, the method includes determining transition probability from the first plurality of topics 302 to the second plurality of topics 304 to identify a most appropriate one of the topics from the solution corpus for a given one of the topics from the problem corpus. The mining and determining steps can be carried out with parallel topic modeler 718.

In some instances, the determining step employs expectation maximization.

In some embodiments (e.g., Matching PTM), in the mining steps, there is a one-to-one correspondence between the first plurality of topics and the second plurality of topics.

In other instances (e.g., Bayesian PTM), an additional step includes incorporating prior knowledge regarding at least selected ones of the first plurality of topics, in the determining step, using a maximum a posteriori technique. The incorporating could include overweighting important words. In some cases, in the incorporating step, the selected ones of the first plurality of topics have manually assigned categories.

The parallel corpus 716, 720 could be generated, for example, by accumulating problem tickets during provision of information technology support for a computer system. In some cases, a subset of the tickets are selected as most representative of a given one of the first plurality of topics, and can be displayed to a human expert.

Steps 704, 706, 708, and 712 may be carried out, for example, with blocks 1302, 1304, 1306, and 1308, respectively. Elements 716, 718 may be realized, for example, within component 1310. Element 720 may be realized, for example, within component 1312.

### Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. With reference to FIG. 14, such an implementation might employ, for example, a processor 1402, a memory 1404, and an input/output interface formed, for example, by a display 1406 and a keyboard 1408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 1402, memory 1404, and input/output interface such as display 1406 and keyboard 1408 can be interconnected, for example, via bus 1410 as part of a data processing unit 1412. Suitable interconnections, for example via bus 1410, can also be provided to a network interface 1414, such as a network card, which can be provided to interface with a computer network, and to a media interface 1416, such as a diskette or CD-ROM drive, which can be provided to interface with media 1418.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 1402 coupled directly or indirectly to memory elements 1404 through a system bus 1410. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 1408, displays 1406, pointing devices, and the like) can be coupled to the system either directly (such as via bus 1410) or through intervening I/O controllers (omitted for clarity).

Network adapters such as network interface 1414 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 1412 as shown in FIG. 14) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 1418 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the figures; by way of example and not limitation, a collection module, a classification module, a diagnosis module, a deployment module, a problem topic modeling module, and a solution topic modeling module. The method steps can then be carried out using the distinct software modules and/or sub-modules of the system, as described above, executing on one or more hardware processors 1402. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
obtaining access to a parallel corpus comprising a problem corpus and a solution corpus;
mining a first plurality of topics from said problem corpus;
mining a second plurality of topics from said solution corpus; and
determining transition probability from said first plurality of topics to said second plurality of topics to identify a most appropriate one of said topics from said solution corpus for a given one of said topics from said problem corpus.

2. The method of claim 1, wherein said determining step employs expectation maximization.

3. The method of claim 1, wherein, in said mining steps, there is a one-to-one correspondence between said first plurality of topics and said second plurality of topics.

4. The method of claim 1, further comprising incorporating prior knowledge regarding at least selected ones of said first plurality of topics, in said determining step, using a maximum a posteriori technique.

5. The method of claim 4, wherein said incorporating comprises overweighting important words.

6. The method of claim 4, wherein, in said incorporating step, said selected ones of said first plurality of topics have manually assigned categories.

7. The method of claim 1, further comprising generating said parallel corpus by accumulating problem tickets during provision of information technology support for a computer system.

8. The method of claim 7, further comprising:
selecting a subset of said tickets as most representative of a given one of said first plurality of topics; and
displaying said selected subset to a human expert.

9. The method of claim 1, further comprising providing a system, wherein the system comprises distinct software modules, each of the distinct software modules being embodied on a computer-readable storage medium, and wherein the distinct software modules comprise a classification module and a diagnosis module;
wherein:
said mining of said first plurality of topics is carried out by said classification module executing on at least one hardware processor;
said mining of said second plurality of topics is carried out by said diagnosis module executing on said at least one hardware processor; and
said determining step is carried out by said diagnosis module executing on said at least one hardware processor.

10. A computer program product comprising a computer readable storage medium having computer readable program code embodied therewith, the computer readable program code comprising:
computer readable program code configured to obtain access to a parallel corpus comprising a problem corpus and a solution corpus;
computer readable program code configured to mine a first plurality of topics from said problem corpus;
computer readable program code configured to mine a second plurality of topics from said solution corpus; and
computer readable program code configured to determine transition probability from said first plurality of topics to said second plurality of topics to identify a most appropriate one of said topics from said solution corpus for a given one of said topics from said problem corpus.

11. The computer program product of claim 10, wherein said computer readable program code configured to determine employs expectation maximization.

12. The computer program product of claim 10, wherein there is a one-to-one correspondence between said first plurality of topics and said second plurality of topics.

13. The computer program product of claim 10, further comprising computer readable program code configured to incorporate prior knowledge regarding at least selected ones of said first plurality of topics, in said computer readable program code configured to determine, using a maximum a posteriori technique.

14. The computer program product of claim 13, wherein said computer readable program code configured to incorporate overweights important words.

15. The computer program product of claim 13, wherein said selected ones of said first plurality of topics have manually assigned categories.

16. The computer program product of claim 10, further comprising computer readable program code configured to generate said parallel corpus by accumulating problem tickets during provision of information technology support for a computer system.

17. The computer program product of claim 16, further comprising:
computer readable program code configured to select a subset of said tickets as most representative of a given one of said first plurality of topics; and
computer readable program code configured to display said selected subset to a human expert.

18. An apparatus comprising:
a memory; and
at least one processor, coupled to said memory, and operative to:
obtain access to a parallel corpus comprising a problem corpus and a solution corpus;
mine a first plurality of topics from said problem corpus;
mine a second plurality of topics from said solution corpus; and
determine transition probability from said first plurality of topics to said second plurality of topics to identify a most appropriate one of said topics from said solution corpus for a given one of said topics from said problem corpus.

19. The apparatus of claim 18, wherein said at least one processor is operative to determine by employing expectation maximization.

20. The apparatus of claim 18, wherein there is a one-to-one correspondence between said first plurality of topics and said second plurality of topics.

21. The apparatus of claim 18, wherein said at least one processor is further operative to incorporate prior knowledge regarding at least selected ones of said first plurality of topics, in said determining, using a maximum a posteriori technique.

22. The apparatus of claim 21, wherein said at least one processor is operative to incorporate by overweighting important words.

23. The apparatus of claim 21, wherein said selected ones of said first plurality of topics have manually assigned categories.

24. The apparatus of claim 18, further comprising a plurality of distinct software modules, each of the distinct software modules being embodied on a computer-readable storage medium, and wherein the distinct software modules comprise a classification module and a diagnosis module;
wherein:
said at least one processor is operative to mine said first plurality of topics by executing said classification module;
said at least one processor is operative to mine said second plurality by executing said diagnosis module; and
said at least one processor is operative to determine by executing said diagnosis module.

25. An apparatus comprising:
means for obtaining access to a parallel corpus comprising a problem corpus and a solution corpus;
means for mining a first plurality of topics from said problem corpus;
means for mining a second plurality of topics from said solution corpus; and
means for determining transition probability from said first plurality of topics to said second plurality of topics to identify a most appropriate one of said topics from said solution corpus for a given one of said topics from said problem corpus.
